(19) United States
(12) Patent Application Publication
(10) Pub. No.: US 2002/0176763 A1
(43) Pub. Date: Nov. 28, 2002

(54) Wood plate connecting element

(76) Inventor: Chin-Tyan Lin, Taichung City (TW)

Correspondence Address: Chin-Tyan Lin, 235 Chung-Ho, Box 8-24, Taipei, TW

(21) Appl. No.: 10/134,824

(22) Filed: Apr. 25, 2002

(30) Foreign Application Priority Data
Apr. 25, 2001 (CN) 01220183.9

(51) Int. Cl. F16B 37/12

(52) U.S. Cl. 411/178

(57) ABSTRACT

A wood plate connecting element is disclosed. The connecting element has an outer periphery which is slightly larger than a diameter of a positioning hole of a wood to be combined thereto. An outer thread section is formed at an outer surface of connecting element. The connecting element has a hollow channel. A rear section of the hollow channel of the connecting element is a hexagonal screw hole. A front section of the hollow channel of the connecting element being formed with an inner thread which is engageable with a stud. An embedding positioning seat is installed at a front end of the connecting element; an interior of the embedding positioning seat has a reduced shape. A foremost of the embedding positioning seat has an embedding rings. A plurality of annular slots are formed on the surface of the connecting element and behind the ring

### FIELD OF THE INVENTION

The present invention relates to connecting elements, and particularly to a wood plate connecting element which can preferred effect than the prior art.

### BACKGROUND OF THE INVENTION

Referring to FIGS. 1 and 2, in the prior art, a wood plate 2 has a positioning hole 21. A connecting element 3 has an outer periphery which is slightly larger than the diameter of the positioning hole 21 preset on the wood plate 2. A thread section 31 is formed at an outer surface of the connecting element 3. A rear section of an interior of the connecting element 3 has a hexagonal screw hole 32. A front section of the interior of the connecting element is formed with a thread section 33. Thereby, the connecting element 3 is screwed into the positioning hole 21 by screwing the hexagonal screw hole 32 so that the thread section 31 at the outer periphery of the connecting element 3 is locked into the positioning hole 21. When the wood plate 2 is desired to combine with another connecting work piece 4, a stud 5 passes through the connecting work piece 4 and then is locked to the thread section 33 in the front section of the connecting element 3. Thereby, the two are locked.

However, the defect is that when the stud 5 rotates for screwing or releasing the work piece 4, the connecting element 3 will rotate with the stud 5 due to rotation between the positioning hole 21 and the thread section 31. Thereby, for a long time, the connecting element 3 will separate with the wood plate 2.

### SUMMARY OF THE INVENTION

Accordingly, the primary object of the present invention is to provide a wood plate connecting element which can improve the defect in the prior art.

To achieve above objects, the present invention provides a wood plate connecting element having a positioning hole on a wood plate. The connecting element has an outer periphery which is slightly larger than the diameter of the positioning hole. An outer thread section is formed at an outer surface of connecting element. A rear section of an interior of the connecting element has a hexagonal screw hole. A front section of an interior of the connecting element is formed with an inner thread section which is engageable with a stud. An embedding positioning seat is installed at a front periphery of the connecting element. An interior of the embedding positioning seat has a reduced shape. A front end of the outer surface of the connecting element has a plurality of rings. A plurality of slots are axially formed along the outer surface of the connecting element.

The various objects and advantages of the present invention will be more readily understood from the following detailed description when read in conjunction with the appended drawing.

### BRIEF DESCRIPTION OF THE DRAWINGS

FIG. 1 is an exploded schematic view of the prior art.

FIG. 2 is a schematic view showing the operation of the prior art.

FIG. 3 is a partial exploded perspective view of the present invention.

FIG. 4 is an assembled partial schematic view of the present invention.

FIG. 5 is an operational schematic view of the present invention.

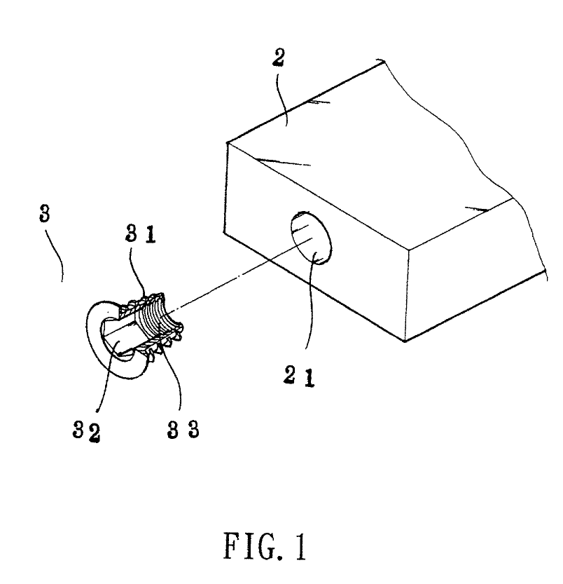

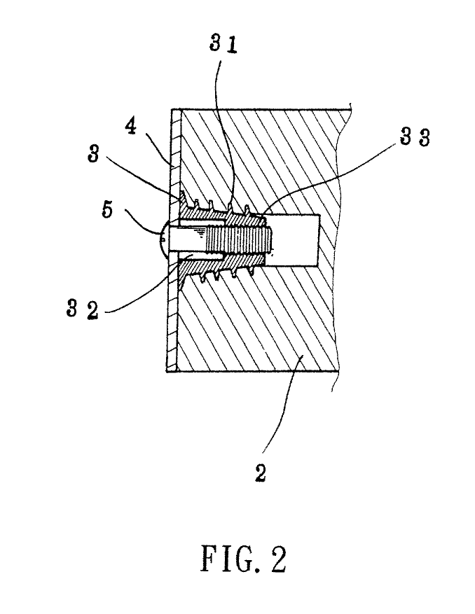

### DETAILED DESCRIPTION OF THE PREFERRED EMBODIMENTS

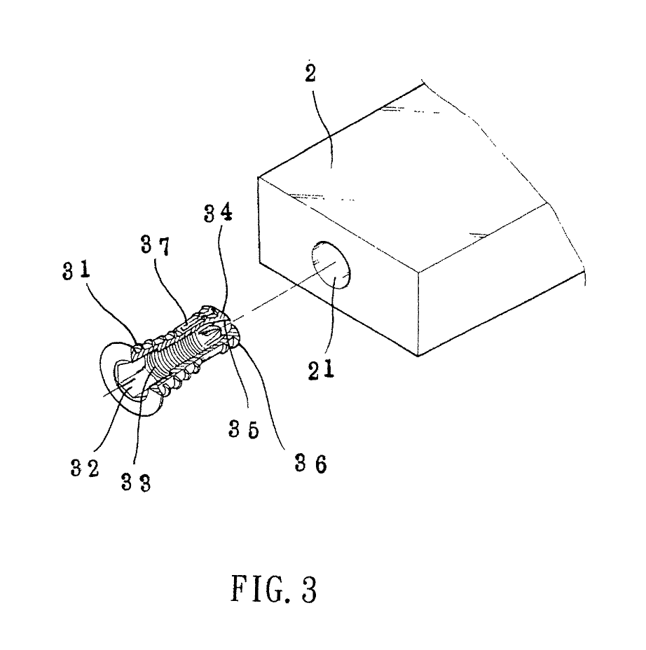

Referring to FIGS. 3, 4, and 5, the wood plate connecting element of the present invention is illustrated. In the present invention, a positioning hole 21 is formed on a wood plate 2. A connecting element 3 has an outer periphery which is slightly larger than the diameter of the positioning hole 21 preset on the wood plate 2. A thread section 31 is formed at an outer surface of the connecting element 3. A rear section of an interior of the connecting element 3 has a hexagonal screw hole 32. A front section of the interior of the connecting element is formed with a thread section 33. The feature of the present invention will be described in the following. An embedding positioning seat 34 is installed at a front end of the connecting element 3. An interior of the embedding positioning seat 34 has a reduced shape 35. The foremost of the embedding positioning seat 34 has an embedding rings 36. A plurality of annular slots are formed on the connecting element and behind the ring 36. A stud 5′ is matched with the thread section 33 at a front end of the connecting element 3. The length of the stud is larger than that of the connecting element 3.

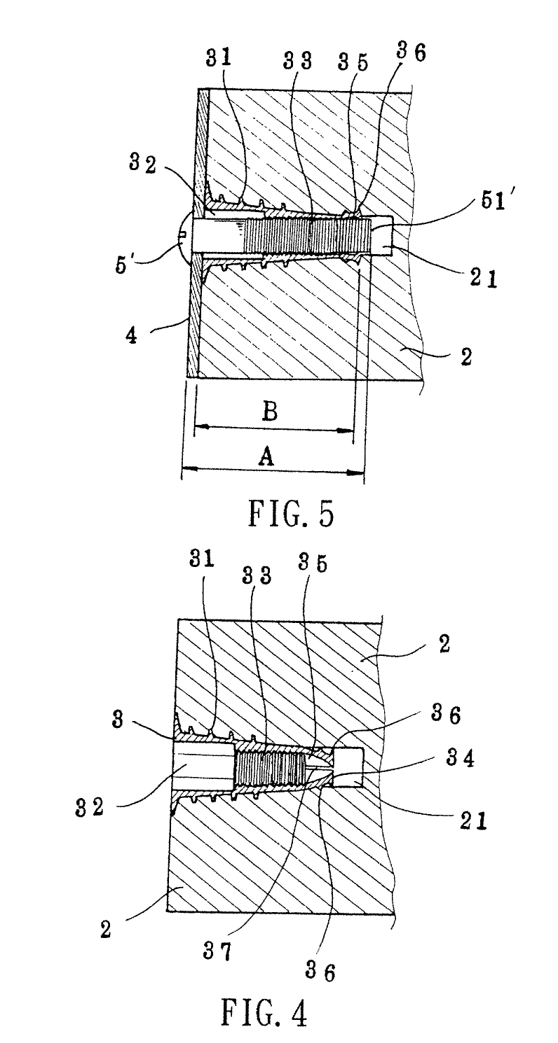

In operation, the connecting element 3 is screwed into the positioning hole 21 of the wood plate 2 by the thread section 31 at the periphery of the connecting element 3, as illustrated in FIG. 4. When the wood plate 2 is combined with other connecting work piece 4, the stud 5′ screws through the connecting work piece 4. Then the foremost end 51′ of the stud 5′ moves toward the interior of the embedding positioning seat 34 so as to expand the embedding positioning seat 34. Thereby, the plurality of rings 36 at the front periphery of the embedding positioning seat 34 can be engaged with the wall of the positioning hole 21. As a result, the connecting element 3 is tightly engaged with the positioning hole 21.

Referring to FIGS. 4 and 5, the rear section of the interior of the connecting element 3 has the hexagonal screw hole 32 and the front section of the interior of the connecting element 3 has a thread section 33. The front periphery of the connecting element 3 has the embedding positioning seat 34. The interior of the embedding positioning seat 34 has no thread section and has a reduced shape 35. A plurality of rings 36 are formed at the foremost of the connecting element 3, and a plurality of slots 37 are axially formed along the front outer surface of the connecting element 3. When the wood plate 2 is combined with other work piece 4, the user uses a stud 5′ to couple the connecting element 3 so that the connecting element 3 is engaged in the positioning hole 21. When the wood plate 2 is detached from the work piece 4, the stud 5′ is released, the connecting element 3 still retains in the positioning hole 21 since the rings 36 are tightly engaged with the wall of the positioning hole 21 by the deformation of the embedding positioning seat 34 in the front end of the connecting element 3.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wood plate connecting element; the connecting element having an outer periphery which is slightly larger than a diameter of a positioning hole of a wood to be combined thereto; an outer thread section is formed at an outer surface of connecting element; the connecting element has a hollow channel; a rear section of the hollow channel of the connecting element being a hexagonal screw hole; a front section of the hollow channel of the connecting element being formed with an inner thread which is engageable with a stud; characterized in that: an embedding positioning seat is installed at a front end of the connecting element; an interior of the embedding positioning seat has a reduced shape; a foremost of the embedding positioning seat has an embedding rings; a plurality of annular slots are formed on the surface of the connecting element and behind the ring.

2. The wood plate connecting element as claimed in claim 1, wherein the stud is longer than the connecting element.
